(19) United States
(12) Patent Application Publication
(10) Pub. No.: US 2012/0085229 A1
(43) Pub. Date: Apr. 12, 2012

(54) MULTIPART-PISTON FOR A CYLINDER ARRANGMENT

(76) Inventors: MARK FAHEY, Mosgiel (NZ); Carsten H. Muller, Stuhr (DE)

(21) Appl. No.: 13/251,545

(22) Filed: Oct. 3, 2011

(30) Foreign Application Priority Data
Oct. 6, 2010 (DE) 10 2010 047 633.1

(51) Int. Cl. F16J 15/00; F16J 1/00

(52) U.S. Cl. 92/249

(57) ABSTRACT

A piston for a cylinder, in particular for a hydraulic piston storage or a hydraulic cylinder having a multipart configuration with two piston parts (11) made of material nontransformable under pressure, subjected to the pressure prevailing in the cylinder, which piston parts comprise, between them, a radially expandable sealing member, with the piston parts (11) arranged such that the pressure in the cylinder axially acting on them effects an increase in the pressure of partial areas of the sealing member against the cylinder wall, wherein the sealing member is made of a support part (12) consisting of the deformable material for a piston seal (20) and at least one piston seal (20) inserted in a groove (19) formed on an outer circumferential surface of the support part (12), and that the cylindrical support part (12) has tapers (13) on both sides with across-piece (14) remaining between them for accepting the two engaging piston parts (11) in such a way that the support part (12) overlaps the piston parts (11) engaging in its tapers with an axial wall section (15).

The invention relates to a piston for a cylinder, in particular a hydraulic piston storage or a hydraulic cylinder having a multipart configuration with two piston parts made of material nontransformable under pressure, subjected to the pressure prevailing in the cylinder, which piston parts comprise, between them, a radially expandable sealing member, with the piston parts arranged such that the pressure in the cylinder axially acting on them effects an increase in the pressure of partial areas of the sealing member against the cylinder wall.

A piston of the above type is described in U.S. Pat. No. 1,828,056 A. The known piston consists of two outer, plate-shaped piston parts comprising, between them, a sealing member preferably made of rubber. The plate-shaped piston parts are connected to each other via a piston rod, passing through the sealing member, in such a way that an adjustment of the distance between the two plate-shaped piston parts is possible with a resulting radial expansion of the sealing member. If, during operation, the pressure in the cylinder acts upon the plate-shaped piston parts, this does not affect the sealing effect of the piston. In addition, the sealing member between the plate-shaped piston parts has recesses situated below external, lateral seal points, which recesses are connected to the inner chamber of the cylinder via a bore passing through the corresponding plate-shaped piston part, so that the pressure prevailing in the cylinder's inner chamber is also present in the recesses of the sealing member, achieving a radial contact pressure of the associated seal points of the sealing member against the cylinder wall. The known piston also has the disadvantage that only small areas of the sealing member are accessible by the increased sealing effect via the recesses in the sealing member. Furthermore, the sealing member made of rubber is generally subject to wear necessitating adjustment of the sealing member via the piston rod. Finally, the multipart piston is made of several individual components and therefore complicated to produce.

From DE 40 08 901 C1, a proposed solution is known for rubber injection machines with a piston having a self-reinforcing seal when under pressure. The corresponding piston is made of two piston parts movable against each other, forming between them an annular groove variable in its width by the relative movement of the piston parts to each other and clamping a sealing ring made of an elastic material. If there is a pressure load on the two piston parts, the piston parts are displaced against each other so that the width of the groove becomes smaller and the sealing member expands outward and provides a seal between the cylinder wall and the piston. This solution has the disadvantage that the respective sealing is effected solely by the sealing ring which is therefore constantly subjected to changes in shape during operation. The sealing materials suitable for the sealing ring do not stand up to the associated loads.

The positioning of a separate piston seal in a circumferential groove of an otherwise rigid support part is known from DE 202 09125 U1.

The object of the invention is to make available a piston of the generic type mentioned in the beginning that provides for secure sealing of the piston in the cylinder, in particular also in the case of expansion of the cylinder over an extended period of operation due to the internal pressures, without readjustment.

The solution of this object is derived from claim 1, advantageous embodiments and later versions of the invention are mentioned in the subclaims.

The basic principle of the invention is that the sealing member consists of a support part made of the deformable material for a piston seal and at least one piston seal inserted in a groove formed on an outer circumferential surface of the support part, and that the cylindrical support part has tapers on both sides with a cross-piece remaining between them for accepting the two engaging piston parts in such a way that the support part overlaps the piston parts engaging in its tapers with an axial wall section. The present invention has the advantage that the change in shape is implemented by the support part supporting the seal and the seal itself remains unstressed. Also, the two piston parts perform no relative movement against each other; rather, the piston parts, as well as the support part, are configured such that the pressure acting axially on the piston parts can be converted into a force component radially acting on the carrier part and therefore radially expanding same.

The special design of the support part and the piston parts engaging with its taper has the additional advantage that both piston parts stabilize the support part in an axial direction so that the multipart piston as a whole has a high degree of rigidity and strength.

To produce the force component radially acting on the support part, one exemplary embodiment of the present invention proposes that both piston parts are configured hollow-cylindrically having a front wall closed toward the abutting cross-piece of the support part formed by the tapers, as well as a circumferential wall abutting the wall segment of the support part overlapping the piston part, with both piston parts having symmetrically-positioned bores radially penetrating their circumferential walls and originating at the axial wall segments of the support part. This configuration ensures the generation of the radially acting force component, as long as the pressure present in the hollow-cylindrical piston parts and therefore also in the bores in the circumferential wall presses radially on the axial wall segments of the support part and pushes them against the cylinder wall enclosing the piston.

This achieves a uniform expansion over the entire piston length of the outer diameter of the piston, defined by the outer diameter of the support part, parallel to the cylinder wall.

Within the context of this invention, it may also be provided that both piston parts are configured as cylindrical bodies where, in this case, correspondingly-positioned axial bores and radial bores originating at same are to be provided in order to transfer the pressure present in each case to the wall segments of the support part.

According to an exemplary embodiment of the invention, it may be provided that two grooves, separated from one another, each having a piston seal inserted in them, are positioned in the circumferential surface of the support part, with the two piston seals positioned in the wall segment of the support part axially overlapping each of the piston parts engaging the tapers of the support part.

According to an exemplary embodiment of the invention, it may be provided that the transition between the cross-piece of the support part and the adjacent axial wall segments bordering the tapers of the support part is configured as a step such that the area of the axial wall segments of the support part existing between the grooves has a greater material thickness than the respective adjacent areas of the wall segments, so that, due to the lesser material thickness, the wall segments bearing the piston seals are easier deformable outward against the cylinder wall.

To the extent provided by an exemplary embodiment of the invention, the fact that the circumferential walls of the hollow-cylindrical piston parts have a greater material thickness than their front wall, the thick-walled circumferential walls support the thin-walled wall segments of the support part against undesired bending.

In a practical embodiment, the two piston parts are made of metal and the support part of plastic.

The drawing depicts an exemplary embodiment of the invention, as described below:

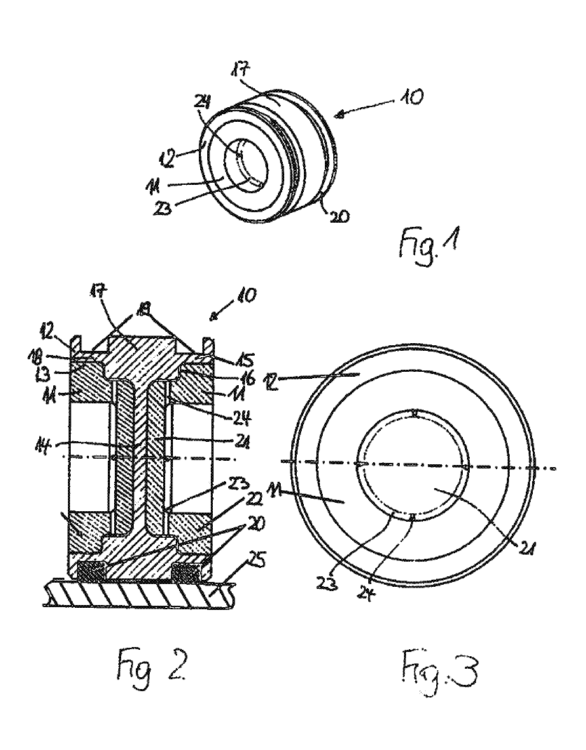

FIG. 1 A perspective view of a multipart piston for a cylinder arrangement,

FIG. 2 A sectional view of the piston according to FIG. 1,

FIG. 3 A front view of the piston according to FIG. 2.

As can be seen from viewing FIGS. 1 and 2 together, piston 10 is made up of two preferably metallic piston parts 11 that enclose between them a support part 12 made of a deformable plastic. Support part 12, in the shape of a cylinder in adaptation to the wall of a cylinder, has tapers 13 on both of its sides, into which the two piston parts 11 are inserted, with a cross-piece 14 remaining between tapers 13 and inserted piston parts 11, and support part 12 overlaps piston parts 11 inserted in tapers 13 with one axial wall section 15 each. In areas 18 of axial wall segments 15 of support part 12 overlapping piston parts 11, one groove 19 each is formed into which a piston seal 20 is inserted, which abuts a cylinder wall enclosing piston 10, this being only indicated in the lower half of FIG. 2. The transition between cross-piece 14 and mid-range 15 of support part 12 is configured with a step 16 such that area 17 of axial wall segments 15 existing between grooves 19 has a greater material thickness than the respective adjacent areas 18 of wall segments 15.

Metallic piston parts 11 inserted in tapers 13 are hollow-cylindrical, configured with a closed front wall 21 abutting cross-piece 14 of support part 12, and with a circumferential wall 22 abutting wall segment 15 of support part 12 overlapping piston part 11. Here, circumferential wall 22 has a greater material thickness than front wall 21. The transition between front wall 21 and circumferential wall 22 is in the form of a chamfer 23, and originating at this chamfer 23, in the depicted exemplary embodiment, are four bores 24, uniformly distributed over the circumference of piston parts 11, extending radially outward to support part 12, and ending at the axial wall segments of support part 12.

If, during operation, line or cylinder pressure is present in the hollow-cylindrical piston parts 11, this pressure also propagates via bores 24 and therefore acts on axial wall segments 15 of support part 12. Because of the lesser rigidity of support part 12, the available pressure causes a radial expansion of support part 12 with axial wall segments 15, which is bordered in radial direction by cylinder wall 25 enclosing piston 10 on the outside. This expansion effect is positively affected by a lateral contraction of support part 12, so that the entire outer surface of support part 12 abuts the inside of cylinder wall 25. At the same time, regarding metallic piston parts 11, there is all-around (hydrostatic) pressure, so that piston parts 11 experience practically no deformations. As the metallic piston parts 11 primarily serve the support action of deformable support part 12, piston parts 11 are thick-walled in the area of their circumferential walls 22 such that they support the thin-walled areas resting on them of axial wall segments 15 bearing piston seal 20 and prevent their undesired bending.

What is claimed is:

1. Piston for a cylinder, in particular for a hydraulic piston storage or a hydraulic cylinder, having a multipart configuration with two piston parts (11) made of material nontransformable under pressure, subjected to the pressure prevailing in the cylinder, which piston parts comprise, between them, a radially expandable sealing member, with the piston parts (11) arranged such that the pressure in the cylinder axially acting on them effects an increase in the pressure of partial areas of the sealing member against the cylinder wall,
wherein the sealing member is made of a support part (12) consisting of the deformable material for a piston seal (20) and at least one piston seal (20) inserted in a groove (19) formed on an outer circumferential surface of the support part (12), and that the cylindrical support part (12) has tapers (13) on both sides with a cross-piece (14) remaining between them for accommodating the two engaging piston parts (11) such that the support part (12) overlaps the piston parts (11) engaged in the tapers (13) with an axial wall segment 15).

2. Piston as recited in claim 1,
wherein the two piston parts (11) are configured hollow-cylindrically with a closed front wall (21) abutting the cross-piece (14), formed by the tapers (13), of the support part (12), as well as with a
circumferential wall (22) abutting the wall segment (15) of the support part (12) overlapping the piston part (11), where both piston parts (11) have symmetrically-positioned bores (24) radially penetrating their circumferential wall (22) and originating at the axial wall segments (15) of the support part (12).

3. Piston as recited in claim 1 or 2,
wherein two grooves (19), separated from one another, each having a piston seal (20) inserted in them, are positioned in the circumferential surface of the support part (12), with the two piston seals (20) positioned in the wall segment (15) of the support part axially overlapping each of the piston parts (11) engaged in the tapers (13) of the support part (12).

4. Piston as recited in one of claims 1 through 3,
wherein the transition between the cross-piece (14) of the support part (12) and the adjacent axial wall segments (15) bordering the tapers (13) of the support part (12) is configured with a step (16) such that the area (17) of the axial wall segments (15) of the support part (12) existing between the grooves (19) has a greater material thickness than the respective adjacent areas (18) of the wall segments (15).

5. Piston as recited in one of claims 1 through 4,
wherein the circumferential walls (22) of the hollow-cylindrical piston parts (11) have a greater material thickness than their front wall (21).

6. Piston as recited in one of claims 1 through 5,
wherein both piston parts (11) are made of metal, and the support part (12) of a synthetic material.
